(19) United States
(12) Patent Application Publication
(10) Pub. No.: US 2023/0380339 A1
(43) Pub. Date: Nov. 30, 2023

(54) REMOTELY CONTROLLED ELECTRIC LAWNMOWER SYSTEM

(71) Applicants: Mark Dively, Rochester, MN (US); Anne Dively, Rochester, MN (US)

(72) Inventors: Mark Dively, Rochester, MN (US); Anne Dively, Rochester, MN (US)

(21) Appl. No.: 17/858,132

(22) Filed: Jul. 6, 2022

Related U.S. Application Data
(60) Provisional application No. 63/345,231, filed on May 24, 2022.

(51) Int. Cl. A01D 34/00; A01D 34/74; A01D 34/78; A01D 69/02

(52) U.S. Cl. CPC A01D 34/008; A01D 34/74; A01D 34/78; A01D 69/02; A01D 2101/00

(57) ABSTRACT

The present invention relates to a battery powered and remotely controlled lawnmower. The lawnmower is configured to be paired with a remote-control device for enabling a user to fully control and operate the lawnmower using the remote-control device. The lawnmower has a control unit for receiving wireless instructions from the remote-control device, a rechargeable battery, and a pair of DC gear motors. The control unit controls the motors for movement of the steering front wheels and rear wheels of the lawnmower. A grass cutter or blade is configured to mow, edge, and blow grass. The remote-control device enables the user to activate, deactivate, accelerate, decelerate, and turn the mower along with adjusting speed of the grass cutter or blade.

### CROSS-REFERENCE TO RELATED APPLICATION

The present application claims priority to, and the benefit of, U.S. Provisional application No. 63/345,231, which was filed on May 24, 2022 and is incorporated herein by reference in its entirety.

### FIELD OF THE INVENTION

The present invention relates generally to lawnmowers. More specifically, the present invention relates to an electric battery powered and remotely controlled lawnmower. The lawnmower has a rechargeable battery and can be paired wirelessly with a battery powered remote-control or transceiver enabling a user to use the remote-control or transceiver for controlling movements and operation of the mower. The mower does not cause pollution and can be used by individuals of all ages and genders. Accordingly, the present disclosure makes specific reference thereto. Nonetheless, it is to be appreciated that aspects of the present invention are also equally applicable to other like applications, devices, and methods of manufacture.

### BACKGROUND

By way of background, a lawn mower is used for the purpose of maintaining lawns, gardens, grounds, and more. More specifically, the lawnmower is used for cutting, mowing, edging, and blowing the grass. Conventional lawnmowers are pushed by a user for mowing grass which requires physical effort of the user. Lawnmowers are heavy devices which require a considerable effort and are often nearly impossible to push by children, elderly, and individuals with injury and limited physical dexterity. Riding lawn mowers are also a difficult task as the mower may get disbalanced and require effort for maintaining balance of the lawnmower. Pushing and riding lawnmowers can put stress on the body, and can cause dehydration, excessive sweating, cramps, tiredness, and more. Individuals desire an improved lawnmower that can be easily operated by individuals of all ages and physical abilities.

Individuals who cannot mow a lawn themselves often hire help or a professional service for mowing. Individuals spend considerable time to search for a service and often such help and service is expensive. Individuals desire an improved lawnmower that eliminates requirement of a help or a service for mowing due to inability of individuals to mow themselves.

A person for mowing a lawn, grounds, and more, is required to operate the lawnmower and physically operate the lawnmower. A person who may want to sit quietly at a place such as on a chair or while having a drink cannot simultaneously mow. Individuals desire a way by which they can remotely control and operate the lawnmower while being physically remote (at some distance) from the lawnmower.

Most of the lawnmowers available in the market run on gas which is not only expensive but also releases harmful gases and pollutants. The use of lawnmowers therefore becomes a hazard for the environment and therefore, individuals desire lawnmowers that do not cause pollution.

Therefore, there exists a long felt need in the art for a lawnmower that can be fully operated remotely by a user. There is also a long felt need in the art for an improved lawnmower that does not create pollution and does not release harmful gases. Additionally, there is a long felt need in the art for an improved lawnmower that can be operated easily by a remote-control device. Moreover, there is a long felt need in the art for a lawnmower that reduces stress on the body of a user while mowing, and thus preventing exhaustion, dehydration, excessive exertion. Further, there is a long felt need in the art for an improved lawnmower that obviates requirement of a hired helper or a service for mowing due to inability of individuals to mow themselves. Furthermore, there is a long felt need in the art for a lawnmower that can be used by individuals of all ages and genders. Finally, there is a long felt need in the art for an improved garden care tool that enables users to mow a lawn with minimal physical effort and without physically operating the lawnmower.

The subject matter disclosed and claimed herein, in one embodiment thereof, comprises a remotely controlled electric lawnmower. The lawnmower is environmentally friendly and reduces stress on the body while mowing. The lawnmower further comprising a pair of steering front wheels and a pair of rear wheels mounted to a frame; a first gear motor for controlling movement of the steering front wheels and a second gear motor for controlling movement of the rear wheels; a grass cutter or blade positioned at the bottom of the frame for mowing grass; a rechargeable battery for providing electric power to the first gear motor, the second gear motor and the grass cutter or blade; a control unit for receiving wireless instructions from a remote device wherein the wireless instructions are configured to control movement, speed, mowing speed of the lawnmower, whereby a user uses the remote device for remotely controlling lawnmower operations.

In this manner, the remotely controlled electric lawnmower of the present invention accomplishes all of the forgoing objectives and provides users with an improved lawnmower capable of being fully operated with a remote-control. The lawnmower enables for wireless operation via a rechargeable battery and the remote-control. The lawnmower is pollution free and environmentally friendly, reduces stress on the body while mowing, and enables individuals of all ages and abilities to mow a lawn by themselves.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a remotely controlled electric lawnmower. The lawnmower further comprising a pair of steering front wheels; a pair of rear wheels; a first gear motor for controlling movement of the steering front wheels; a second gear motor for controlling movement of the rear wheels; a driving mechanism or drive shaft for driving a grass cutter or blade for mowing grass; a rechargeable battery for providing electric power to the first gear motor, the second gear motor and the driving mechanism or drive shaft; a control unit for receiving wireless instructions from a remote device wherein the wireless instructions are configured to control movement, speed, mowing speed of the lawnmower, whereby a user uses the remote device for remotely controlling lawnmower operations.

In yet another embodiment, the lawnmower has an antenna coupled to the control unit enabling the control unit to receive wireless instructions from the remote device.

In yet another embodiment, the driving mechanism or drive shaft is configured to lift the grass cutter or blade for avoiding bumps in the path of the lawnmower.

In yet another embodiment, the battery is positioned in a battery cover and is a lead-acid or lithium-ion battery.

In yet another embodiment, the battery has a voltage range from 30 volts to 60 volts.

In yet another embodiment, the grass cutter or blade rotates around a vertical shaft and is used for mowing, trimming, and edging.

In yet another embodiment, the lawnmower has a collection box or grass catcher for collecting mowed grass.

In yet another embodiment, an environmentally friendly and remotely controlled lawnmower is disclosed. The lawnmower is configured to be remotely controlled by a remote-control device and includes a pair of steering front wheels attached to a first DC gear motor; a pair of rear wheels attached to a second DC gear motor; a grass cutter or blade attached to a driving mechanism or drive shaft; a control unit for controlling operations of the first DC gear motor, the second DC gear motor and the driving mechanism or drive shaft; a battery for providing electric power to the gear motors and the driving mechanism or drive shaft, wherein the steering front wheels move right or left when the control unit receives a wireless instruction from a remote-control device, and wherein the grass cutter or blade is raised vertically when the control unit receives another wireless instruction from the remote-control device.

In yet another embodiment, a method of remotely controlling an electric lawnmower is described. The method includes the steps of pairing a remote-control device and the electric lawnmower; receiving, by a control unit of the lawnmower from the remote-control device, a lawnmower activation wireless command; receiving, by the control unit of the lawnmower from the remote-control device, a movement instruction for steering front wheels and rear wheels of the lawnmower; instructing, by the control unit of the lawnmower, movement of the steering front wheels and the rear wheels; receiving, by the control unit of the lawnmower from the remote-control device, a movement instruction for grass cutter or blade of the lawnmower; and receiving, by the remote-control device, battery status message from the control unit of the lawnmower.

In yet another embodiment, the remote-control device has a wireless transceiver for transmitting and receiving messages to/from the control unit of the lawnmower.

In yet another embodiment, the lawnmower is an electric lawnmower.

In yet another embodiment, the lawnmower does not use gas and does not create pollution.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a remotely controlled lawnmower of the present invention in accordance with the disclosed architecture;

FIG. 2A illustrates a detailed view of the remote-control device 108 used for operating the lawnmower 100 of the present invention in accordance with the disclosed architecture;

FIG. 2B illustrates a schematic block diagram of the one potential embodiment of the remote-control device used in the present invention showing internal components in accordance with the disclosed architecture;

FIG. 3 illustrates a vertical sectional view of the lawnmower 100 of the present invention in accordance with the disclosed architecture; and

FIG. 4 illustrates a flow diagram depicting exemplary steps performed by the remotely controlled electric lawnmower 100 for mowing grass in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for a lawnmower that can be fully operated remotely by a user. There is also a long felt need in the art for an improved lawnmower that does not create pollution and does not release harmful gases. Additionally, there is a long felt need in the art for an improved lawnmower that can be operated easily by a remote-control device. Moreover, there is a long felt need in the art for a lawnmower that reduces stress on the body of a user while mowing, and thus preventing exhaustion, dehydration, excessive exertion. Further, there is a long felt need in the art for an improved lawnmower that obviates requirement of a hired helper or a lawn service for mowing due to inability of individuals to mow themselves. Furthermore, there is a long felt need in the art for a lawnmower that can be used by individuals of all ages and genders. Finally, there is a long felt need in the art for an improved garden care tool that enables users to mow a lawn with minimal physical effort and without physically operating the lawnmower.

The present invention, in one exemplary embodiment, is an environmentally friendly and remotely controlled electric lawnmower. The lawnmower is configured to be remotely controlled by a remote-control device and includes a pair of steering front wheels attached to a first DC gear motor; a pair of rear wheels attached to a second DC gear motor; a grass cutter or blade attached to a driving mechanism or drive shaft; a control unit for controlling operations of the first DC gear motor, the second DC gear motor and the driving mechanism or drive shaft; a battery for providing electric power to the gear motors and the driving mechanism or drive shaft, wherein the steering front wheels move right or left when the control unit receives a wireless instruction from a remote-control device, and wherein the grass cutter or blade is raised vertically when the control unit receives another wireless instruction from the remote-control device.

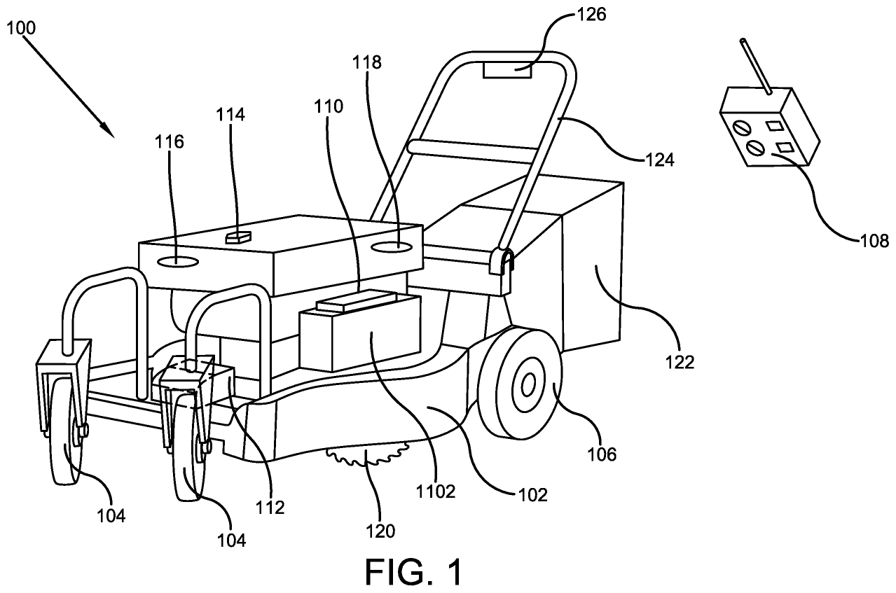

Referring initially to the drawings, FIG. 1 illustrates a perspective view of one potential embodiment of the remotely controlled lawnmower 100 of the present invention in accordance with the disclosed architecture. The remotely controlled lawnmower 100 is designed as an improved lawnmower capable of being operated remotely by a user using a remote-control device 102. The lawnmower 100 is powered by a rechargeable battery and does not use gas for operation and therefore, is environmentally friendly and cost effective.

More specifically, the lawnmower 100 has a frame 102 that has a pair of steering front wheels 104 and a pair of rear wheels 106 for movement of the lawnmower 100. The steering front wheels 104 are pivotable to provide direction and turning upon control by the remote-control device or transceiver 108. A rechargeable battery 110 is positioned in a battery cover 1102 and is configured to provide electric power for operation of the lawnmower 100. The battery 110 preferably provides Direct Current (DC) and the lawnmower 100 may operate directly on DC or alternatively on Alternating Current (AC). The battery 110 can be a lead-acid or lithium-ion battery and can have a voltage range from 30 volts to 60 volts depending on size of the lawnmower 100. A control unit or receiver 112 having one or more computing processors is configured to receive wireless instructions from the remote-control device 108 and controls the operation of the lawnmower 100. The control unit 112 activates the battery 110 to provide electric power to the lawnmower. Further, the control unit 112 is coupled with an antenna 114 that facilitates wireless communication between the control unit 112 and the remote-control device 110.

The control unit or receiver 112 is coupled to two DC gear motors 116, 118 for controlling movement of the lawnmower 100. The first DC gear motor 116 helps in acceleration, deceleration, and sideways movement of the steering front wheels 104 and the second DC gear motor 118 controls movement of the rear wheels 106. The control unit or receiver 112 is configured to redirect the wheels of the lawnmower 100 in response to the signals received from the remote-control device 108. The battery 110 is configured to provide at least 25 Ampere to each DC gear motor for operating the lawnmower 100.

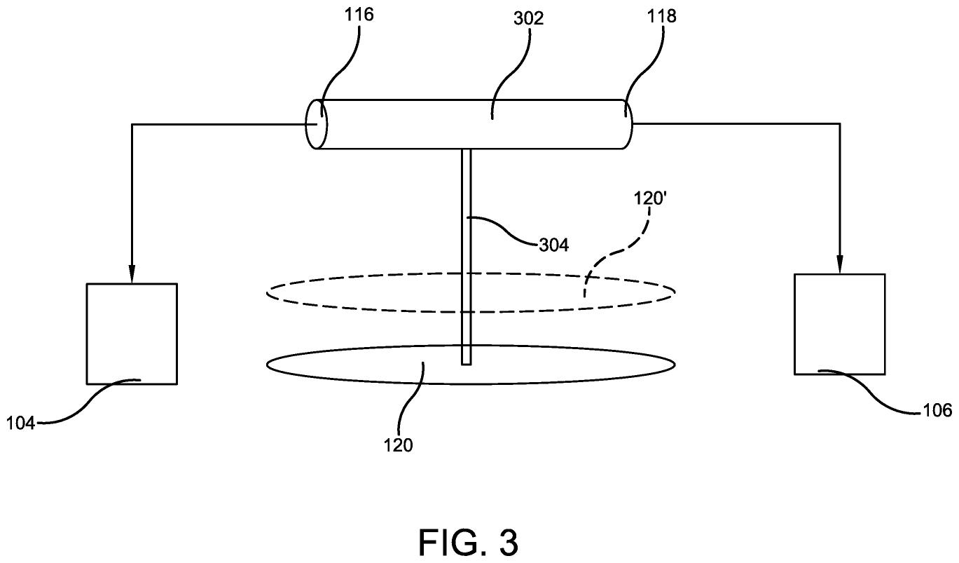

The lawnmower 100 has a grass cutter or blade 120 secured to the frame 102. The grass cutter or blade 120 is driven by the battery 110 using a driving mechanism or drive shaft (shown in FIG. 3) and can be a rotary cutter, grass comber, or more. In one exemplary embodiment, the lawnmower 100 has a collection box or grass catcher 122 for accommodating mowed grass. In alternative embodiment, the collection box or grass catcher 122 may not be required and can be removed from the lawnmower 100.

The lawnmower 100 of the present invention has a simple and lightweight structure, low handling and maintenance costs, and simple and cost-effective repairs. Further, the lawnmower 100 is environmentally friendly, causes no pollution and noise. The lawnmower 100 may come in different sizes and designs and can be used at home gardens, backyards, playgrounds, and can also be used for removing weeds. For manually pulling and pushing the lawnmower 100, an extendable handle 124 is provided enabling a user to operate the lawnmower 100, the handle 124 also has a covered pocket 126 for securely storing the remote-control device 108.

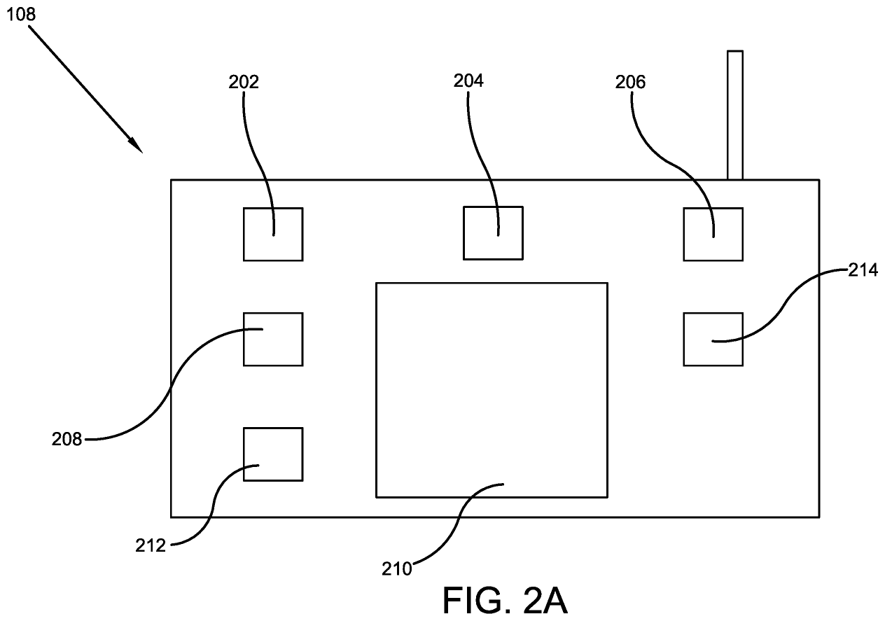

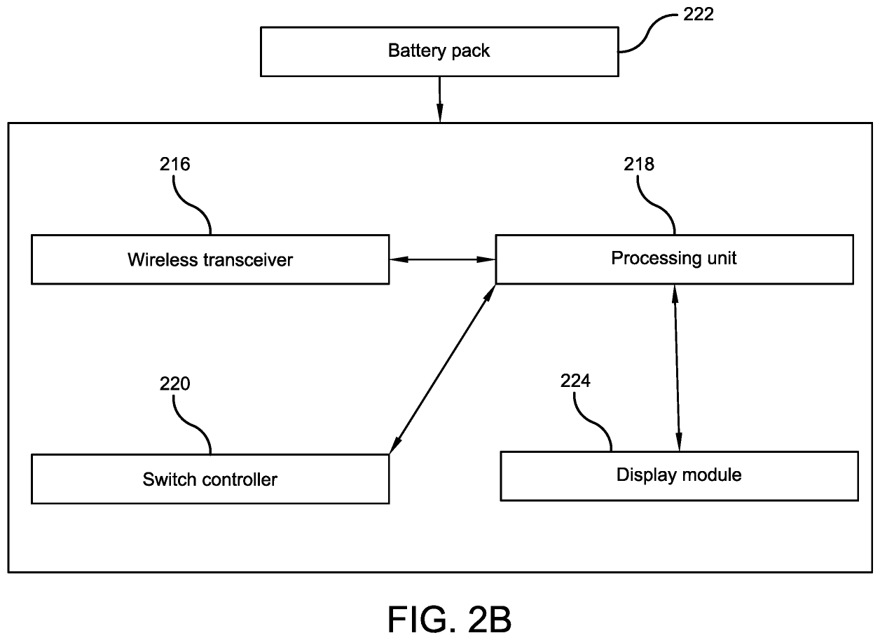

FIG. 2A illustrates a detailed view of the remote-control device 108 used for operating the lawnmower 100 of the present invention in accordance with the disclosed architecture. The wireless remote-control device 108 is configured to receive input from an operator of the lawnmower 100 indicating the movement of the lawnmower 100 that operator wants to perform and transmits a signal to the control unit or receiver 112. The wireless remote-control device 108 is coupled to the electric lawnmower 100 through an Infrared or any other wireless channel. A start/stop button or control 202 is configured to activate and deactivate the lawnmower 100, a speed increase/decrease button or control 204 is configured to adjust movement speed of the wheels of the lawnmower 100, a right turn button or control 206 is configured to turn the steering front wheels of the lawnmower 100 towards right direction and a left turn button or control 208 is configured to turn the steering front wheels towards left direction.

The remote-control device 108 may have a display 210 configured to display the battery level of the rechargeable battery 110 of the remotely controlled electric lawnmower 100. Further, the display 210 may also display a warning signal indicating any malfunctioning in the lawnmower 100. The remote-control device 108 has a built-in wireless transceiver (not shown) for connecting to the control unit 112 of the remotely controlled electric lawnmower 100.

A cutter speed adjuster button or control 212 is configured to adjust speed of the grass cutter or blade 120 enabling use of the lawnmower 100 for mowing various types of grass, weeds, and more. A cutter height adjuster button or control 214 is configured to adjust vertical height of the cutter 120 (described in FIG. 3) thereby enabling the lawnmower 100 to work on different terrains and does not strike on obstacles during operation.

FIG. 2B illustrates a schematic block diagram of the one potential embodiment of the remote-control device used in the present invention showing internal components in accordance with the disclosed architecture. The remote-control device 108 has a wireless transceiver 216 for transmitting and receiving wireless signals having encoded instructions encoded therein. The wireless transceiver 216 is coupled to a processing unit 218 wherein the processing unit 218 is coupled to a switch controller 220 for actuating the individual switch or button or controls described in FIG. 2A. The remote-control device 108 has a battery pack 222 for providing electric power to the device 108 and the battery pack 222 is designed as replaceable and rechargeable. A display module 224 is configured to display the received battery information/charge status and other information on the display device of the remote-control device 108.

FIG. 3 illustrates a vertical sectional view of the lawnmower 100 of the present invention in accordance with the disclosed architecture. The grass cutter or blade 120 is configured to move vertically along a longitudinal driving shaft 304 coupled to a driving mechanism or drive shaft 302 from a first position shown in solid lines to a raised position 120′. The driving shaft 304 also provides power from the driving mechanism or drive shaft 302 for rotation of the grass cutter or blade 120.

The driving shaft 304 provides a channel along its length for vertical movement of the cutter 120 when the cutter height adjuster button or control 214 is pressed by a user on the remote-control device 108. The first gear motor 116 is coupled through a wired connection to the steering front wheels 104 and the second gear motor 118 is coupled to the rear wheels 106 for driving the wheels for movement of the remotely controlled electric lawnmower 100.

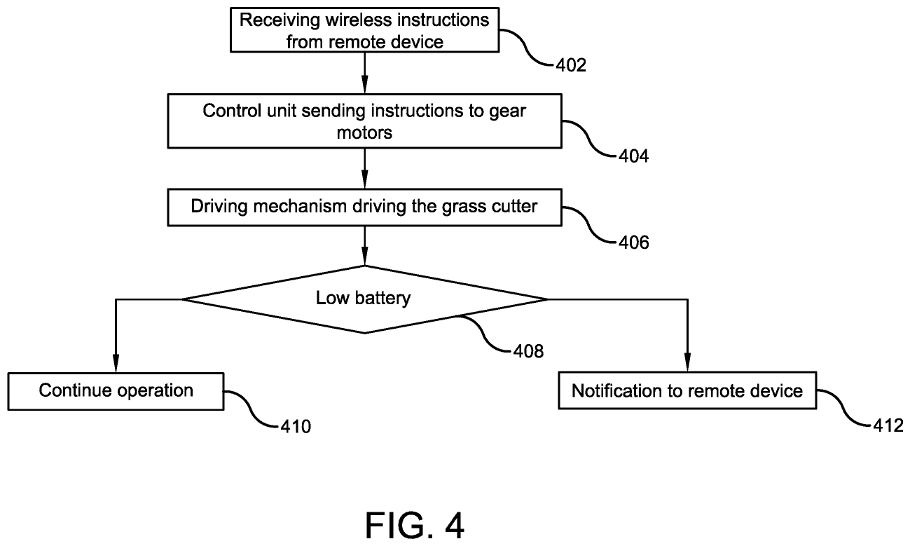

FIG. 4 illustrates a flow diagram depicting exemplary steps performed by the remotely controlled electric lawnmower 100 for mowing grass in accordance with the disclosed architecture. Initially, wireless instruction for activating the lawnmower is received by the control unit of the lawnmower (Step 402). Based on the received movement instructions from the remote device, the control unit sends instructions to the gear motors of the lawnmower (Step 404) for controlling movement of the wheels. For mowing grass, the driving mechanism or drive shaft of the lawnmower drives the grass cutter or blade positioned at the bottom of housing of the lawnmower (Step 406). The control unit of the lawnmower 100 checks for the battery power (Step 408) and in situations where the battery is determined to be sufficient, then, the operation of the lawnmower 100 is continued (Step 410) and if the battery is found to be low, then, a notification is sent to the remote-control device (Step 412).

It should be noted that the remote-control device 108 and the control unit 112 of lawnmower 100 can transfer warning messages, messages involving configuration of the lawnmower 100, and more. Further, the lawnmower 100 and the remote device 108 comes together commercially as a remote-controlled lawnmower system wherein the remote device 108 can be paired with the lawnmower 100. The lawnmower 100 can be easily operated by young children and elderly individuals without stressing their body while mowing and therefore, preventing exhaustion, dehydration, excessive sweating, and more.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “remote controlled lawnmower”, “lawnmower”, “electric lawnmower”, and “remotely controlled electric lawnmower” are interchangeable and refer to the remotely controlled electric lawnmower 100 of the present invention.

Notwithstanding the forgoing, the remotely controlled electric lawnmower 100 of the present invention can be of any suitable size and configuration as is known in the art without affecting the overall concept of the invention, provided that it accomplishes the above stated objectives. One of ordinary skill in the art will appreciate that the remotely controlled electric lawnmower 100 as shown in the FIGS. are for illustrative purposes only, and that many other sizes and shapes of the remotely controlled electric lawnmower 100 are well within the scope of the present disclosure. Although the dimensions of the remotely controlled electric lawnmower 100 are important design parameters for user convenience, the remotely controlled electric lawnmower 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A remotely controlled lawnmower comprising:
a lawnmower having a frame, a pair of steering front wheels, a pair of rear wheels, a cutter blade, a control unit, a first DC gear motor, a second DC gear motor, and a drive shaft;
a remote-control device having a wireless transceiver including controls selected from a group consisting of a start/stop control, a speed control, a right turn control, a left turn control, a cutter blade speed control, and a cutter height adjuster control;
a rechargeable battery for powering said lawnmower;
wherein said control unit having a receiver to receive wireless instructions from said remote-control device;
wherein said pair of steering front wheels pivotable to provide turning upon control by a user of said remote-control device; and
further wherein said speed control configured to transmit a signal to said control unit to adjust movement speed of said pair of rear wheels of said lawnmower.

2. The remotely controlled lawnmower of claim 1, wherein said start/stop control configured to transmit a signal to said control unit to activate and deactivate said lawnmower.

3. The remotely controlled lawnmower of claim 2, wherein said right turn control configured to transmit a signal to said control unit to turn said pair of steering front wheels of said lawnmower towards a right direction, wherein said left turn control configured to transmit a signal to said control unit to turn said pair of steering front wheels of said lawnmower towards a left direction.

4. The remotely controlled lawnmower of claim 3, wherein said cutter speed control transmits a signal to said control unit to adjust a speed of said drive shaft of said cutter blade.

5. The remotely controlled lawnmower of claim 4, wherein said cutter height control transmits a signal to said control unit to adjust a vertical height of said drive shaft of said cutter blade.

6. The remotely controlled lawnmower of claim 5, wherein said remote-control device comprises a display module to display a received battery charge status from said control unit of said lawnmower.

7. The remotely controlled lawnmower of claim 6, wherein said rechargeable battery is a lithium-ion battery having a voltage range from 30 volts to 60 volts.

8. The remotely controlled lawnmower of claim 1, wherein said control unit coupled to said first DC gear motor and said second DC gear motor, and further wherein said first DC gear motor controls pivotal movement of said pair of steering front wheels and said second DC gear motor controls speed of said pair of rear wheels.

9. The remotely controlled lawnmower of claim 8, wherein said rechargeable battery supplies at least 25 Ampere to each said first DC gear motor and said second DC gear motor.

10. The remotely controlled lawnmower of claim 5, wherein said remote-control device comprises a display module to display a received warning signal from said control unit indicating a malfunction in said lawnmower.

11. A remotely controlled lawnmower comprising:
a lawnmower having a frame, a pair of steering front wheels, a pair of rear wheels, a cutter blade, a control unit, a first DC gear motor, a second DC gear motor, and a drive shaft;
a remote-control device having a wireless transceiver including controls selected from a group consisting of a start/stop control, a speed control, a right turn control, a left turn control, a cutter blade speed control, and a cutter height adjuster control;
a rechargeable battery for powering said lawnmower;
wherein said control unit having a receiver to receive wireless instructions from said remote-control device;
wherein said control unit coupled to said first DC gear motor and said second DC gear motor;
wherein said first DC gear motor controls pivotal movement of said pair of steering front wheels and said second DC gear motor controls speed of said pair of rear wheels;
wherein said speed control configured to transmit a signal to said control unit to adjust movement speed of said pair of rear wheels of said lawnmower; and
further wherein said right turn control and said left turn control configured to transmit signals to said control unit to pivot movement of said pair of steering front wheels.

12. The remotely controlled lawnmower of claim 11, wherein said start/stop control configured to transmit a signal to said control unit to activate and deactivate said lawnmower.

13. The remotely controlled lawnmower of claim 12, wherein said cutter speed control transmits a signal to said control unit to adjust a speed of said drive shaft of said cutter blade.

14. The remotely controlled lawnmower of claim 13, wherein said cutter height control transmits a signal to said control unit to adjust a vertical height of said drive shaft of said cutter blade.

15. The remotely controlled lawnmower of claim 14, wherein said remote-control device comprises a display module to display a received battery charge status from said control unit of said lawnmower.

16. The remotely controlled lawnmower of claim 15, wherein said rechargeable battery is a lithium-ion battery having a voltage range from 30 volts to 60 volts.

17. The remotely controlled lawnmower of claim 16, wherein said rechargeable battery supplies at least 25 Ampere to each said first DC gear motor and said second DC gear motor.

18. A remotely controlled lawnmower comprising:
a lawnmower having a frame, a pair of steering front wheels, a pair of rear wheels, a cutter blade, a control unit, a first DC gear motor, a second DC gear motor, and a drive shaft;
a remote-control device having a wireless transceiver including controls selected from a group consisting of a start/stop control, a speed control, a right turn control, a left turn control, a cutter blade speed control, and a cutter height adjuster control;
a rechargeable battery for powering said lawnmower;
wherein said control unit having a receiver to receive wireless instructions from said remote-control device;
wherein said control unit coupled to said first DC gear motor and said second DC gear motor;
wherein said first DC gear motor controls pivotal movement of said pair of steering front wheels and said second DC gear motor controls speed of said pair of rear wheels;
wherein said speed control transmits a signal to said control unit to adjust movement speed of said pair of rear wheels of said lawnmower;
wherein said right turn control and said left turn control transmits signals to said control unit to pivot movement of said pair of steering front wheels;
wherein said cutter height control transmits a signal to said control unit to adjust a vertical height of said drive shaft of said cutter blade;
wherein said rechargeable battery is a lithium-ion battery having a voltage range from 30 volts to 60 volts; and
further wherein said rechargeable battery supplies at least 25 Ampere to each said first DC gear motor and said second DC gear motor.

19. The remotely controlled lawnmower of claim 18, wherein said cutter speed control transmits a signal to said control unit to adjust a speed of said drive shaft of said cutter blade.

20. The remotely controlled lawnmower of claim 19, wherein said remote-control device comprises a display module to display a received battery charge status from said control unit of said lawnmower.
